(19) United States
(12) Patent Application Publication
(10) Pub. No.: US 2021/0171261 A1
(43) Pub. Date: Jun. 10, 2021

(54) Pallet Bag System

(71) Applicant: Curation Foods, Inc, Santa Maria, CA (US)

(72) Inventors: Steven Bitler, Menlo Park, CA (US); Angel Reyes, Santa Maria, CA (US); Shehbaz Singh, Santa Maria, CA (US)

(73) Assignee: Curation Foods, Inc., Santa Maria, CA (US)

(21) Appl. No.: 17/023,140

(22) Filed: Sep. 16, 2020

Related U.S. Application Data
(63) Continuation-in-part of application No. 16/513,673, filed on Jul. 16, 2019.
Application No. 16/513,673 is a continuation-in-part of application No. 15/604,629, filed on May 24, 2017, now abandoned.
(60) Provisional application No. 62/900,990, filed on Sep. 16, 2019.
(60) Provisional application No. 62/698,908, filed on Jul. 16, 2018.
(60) Provisional application No. 62/340,966, filed on May 24, 2016.

(51) Int. Cl. B65D 71/00; B65D 88/16; B65D 90/16

(52) U.S. Cl. CPC B65D 71/0096; B65D 2588/165; B65D 90/16; B65D 88/1612

(57) ABSTRACT

This invention relates to a pallet bag system for bags enclosing items, pallets loaded with bags containing items, and containers containing such loaded pallets.

### CROSS-REFERENCE TO RELATED APPLICATIONS

This application claims the benefit of U.S. Provisional Patent Application No. 62/900,990 and is a continuation in part of U.S. patent application Ser. No. 16/513,673, filed Jul. 16, 2019, which claims the benefit of U.S. Provisional Patent Application No. 62/698,908, filed Jul, 16, 2018, and is a continuation in part of U.S. patent application Ser. No. 15/604,629, filed May 24, 2017, which claims the benefit of U.S. Provisional Patent Application No. 62/340,966, filed May 24, 2016, and further claims the benefit of PCT/US2019/042687, filed Jul. 19, 2019, which claims the benefit of U.S. Provisional Patent Application No. 62/701,364, filed on Jul. 20, 2018 and relates to the following commonly assigned applications, including application Ser. No. 16/512,372, filed Jul. 16, 2019, which claims the benefit of U.S. Provisional Patent Application No. 62/698,796, application Ser. No. 13/368,216, filed Feb. 7, 2012, application Ser. No. 13/368,216, filed Feb 7, 2012, which is a continuation of Ser. No. 09/858,190, filed May 15, 2001, now U.S. Pat. No. 8,110,232, which is also related to Provisional Application Ser. No. 60/325,762, filed May 26, 2000 and application Ser. No. 09/580,379. This application is also related to (1) application Ser. No. 09/989,682, filed Nov. 20, 2001, now U.S. Pat. No. 7,601,374, which is a continuation-in-part of Ser. No. 09/858,190, and (2) application Ser. No. 12/553,852 filed Sep. 3, 2009, now U.S. Pat. No. 8,092,848, which is a divisional of Ser. No. 09/989,682. The entire disclosures of each of the patents and applications above and within this specification are incorporated herein by reference for all purposes.

### BACKGROUND OF THE INVENTION

### Field of the Invention

This invention relates to bags for enclosing items, pallets loaded with bags containing items, and containers containing such loaded pallets.

### Introduction to the Invention

It is known to use a polymeric bag to enclose items that are to be transported on a pallet, to load a polymeric bag enclosing such items onto a pallet, and to place the loaded pallet into a container, for example a shipping or trucking container, which may be refrigerated. The top surface of a pallet often has protrusions of various kinds, for example nails and pieces of broken wood, which can damage the base of a bag placed on the pallet. Damage to the bag is always undesirable, but especially so when the bag is used to transport respiring biological material; when the bag is so used, it usually includes an atmosphere control member (ACM) which controls or helps to control the atmosphere surrounding the respiring biological material. If the bag is damaged, this can prevent the desired control of the atmosphere around the respiring biological material. The current practice, in order to reduce the danger of damaging the bag, is to place a protective sheet (also known as the deck sheet), e.g. of cardboard or corrugated material, on the pallet before the bag is placed on it. Reference may be made, for example, to U.S. Pat. Nos. 7,770,366 and 8,024,912, the entire contents of which are incorporated herein by reference for all purposes.

### SUMMARY OF THE INVENTION

In a first aspect, this invention provides a bag which can be used to enclose items, the bag comprising

(1) a base; and

(2) walls which (i) comprise polymeric sheet material, (ii) are attached to each other, (iii) can be folded around the base to facilitate placing the items on the base, and (iv) can be unfolded to extend upwards from the base to enclose items that have been placed on the base.

In an embodiment the reinforced base portion can be used separately from the walls, where the reinforced portion extends up from the base about 4″ to about 12″ and is then connected to a bag of varying sizes to accommodate the load. In this way, the same reinforced base and extending about 4″ to about 12″ wall portions therefrom can be used to be attached to a variety of bag sizes between the about 4″ to about 12″ wall portion, as long as about 2″ remain below the end of the bag between the base and the end of the bag to allow for taping.

The flexible base or tray has benefits similar to the rigid tray identified and claimed in U.S. Pat. No. 15/604,629 and the height of the wall extending from the base is designed to not prevent cooling of the organic material stacked in the flexible base or tray. Ideally, the flexible reinforced base is used in the field to stack cartons of organic material from the field and used to transport both the reinforced base and organic materials to the apparatus and process for packaging materials as described in U.S. patent application Ser. Nos. 16/513,673 and 15/604,629. The use of the base portion with about 4″ to about 12″ wall portions may be used with both “top-down” bagging processes such as in the '673 application and “bottom-up” bagging processes as in the '629 application, both of which applications are incorporated by reference in their entirety for all purposes.

In an embodiment relating to either bagging process, the process in the '673 application may alternatively be used without the use of the spatula system described therein and may alternatively be used with a four-sided squeeze mechanism to pick up the loaded materials instead of the two-sided squeeze mechanism, which helps to maintain the integrity of the stack. Where the four-sided squeeze mechanism is employed without a spatula mechanism, the conveyer line may be continuous without the need for the transfer of the materials and base from one portion of the conveyer to another. Instead the pallet may be removed when the four-sided squeeze mechanism lifts the materials and reinforced base and a bottom-up bag may be inserted below the base for processing such as in the '673 application. Alternatively, the organic materials and reinforced base with about 4″ to about 12″ wall portions may proceed to “top-down” bagging stations where a bag of sufficient size is brought down from above the materials and attached to the about 4″ to about 12″ wall portions leaving sufficient room for affixing the top-down bag. In a preferred embodiment, both the top-down and bottom-up bags contain an atmosphere control member (ACM) or membrane, such as a BreatheWay® membrane. If using a top-down bag to engage with the about 4″ to about 12″ reinforced wall portions extending from the base, reinforced tape may not need to be used or may be used for added protection.

In an aspect of using a separate reinforced base and about 4″ to about 12″ reinforced wall portions to engage with a top-down bag, it is preferred to assist the about 4″ to about 12″ wall portions to remain extended upward prior to loading organic materials in the field. This may be accomplished using a removable boot, for example in each corner of the base portion or alternatively a plastic or other bendable but semi-rigid or rigid strip may be placed such that it supports the about 4″ to about 12″ wall portions in extending and substantially staying up extending from the base to facilitate loading of organic material cartons/crates on the base without the need to manually hold up the wall portions until the organic material cartons/crates are in place.

Using a flexible reinforced base such as described herein will help prevent punctures or tears during processing and movement, which helps the pallet bag maintain its integrity and atmosphere.

The horizontal base having properties, for example tear strength and/or puncture resistance and/or stiffness, which reduce the danger that the base will be damaged by imperfections in a surface onto which the base is put.

The walls of the bag can comprise lower portions and upper portions, and, optionally, intermediate portions, the upper portions being composed of a polymeric sheet material, and the lower portions and to any intermediate portions (the lower portions and any intermediate portions preferably also being composed of a polymeric sheet material). The lower portions are attached to the base and to the upper portions.

In one embodiment, the lower portions have properties, for example tear strength and/or puncture resistance and/or stiffness, which reduce the danger that the walls will be damaged by contact with adjacent surfaces, for example other pallets. For example, the lower portions can have a tear strength which is substantially greater than the tear strength of the upper portions of the walls and/or a puncture resistance which is substantially greater than the puncture resistance of the upper portions of the walls, and/or a stiffness substantially greater than the upper portions of the walls. In another embodiment, the lower portions and the upper portion of the walls are different parts of the same polymeric sheet material.

In a second aspect, this invention provides an assembly which comprises

(1) a horizontal surface, for example the top surface of a pallet, and

(2) a bag according to the first aspect of the invention, the base of the bag being in contact with the horizontal surface.

In this assembly, the walls of the bag can be folded downwards while the items to be enclosed are placed on the base, and can be subsequently unfolded so that the items are enclosed by the bag.

In a third aspect, this invention provides a method of making an assembly according to the second aspect of the invention, the method comprising the steps of providing a bag according to the first aspect of the invention,

(a) providing a horizontal surface, for example the top of a pallet,

(b) placing the base of the bag on the horizontal surface, with the walls folded down around the sides of the base,

(c) loading items on top of the base of the bag, and unfolding the walls of the bag so that they enclose the items.

In a fourth aspect, this invention provides a method of making a pallet bag according to the first aspect of the invention, the method comprising the steps of

(a) providing a tube of apolymeric composition,

(b) flattening the tube (with or without gussets),

(c) cutting or perforating the tube to a desired length,

(d) before or after, or simultaneously with, step (C), sealing the bottom of the tube to form a bag,

(e) simultaneously with step (D) or after step (D), securing the bottom of the bag to the horizontal base of the bag, for example by heat sealing and/or through the use of an adhesive.

In a fifth aspect, this invention provides a method of making a pallet bag according to the first aspect of the invention, the method comprising the steps of

(a) providing a base for the bag which (i) is resistant to damage and (ii) comprises a horizontal portion and vertical portions which extend upwards from the edges of the horizontal portion,

(b) securing the walls of the polymeric sheet material to the vertical portions of the base, for example by heat sealing and/or through the use of an adhesive.

In describing and claiming the invention, the references to horizontal, vertical, downwards, upwards, sideways, around, etc. assume that the base of the bag is substantially horizontal.

### BRIEF DESCRIPTION OF THE DRAWINGS

The invention is illustrated in the accompanying drawings, which are diagrammatic in nature and are not drawn to scale, and in which

FIG. 1 is a perspective view of a bag according to the first aspect of the invention on top of a pallet, and

FIG. 2 shows successive stages in the production of an assembly according to the second aspect of the invention.

FIGS. 3A and 3B show side views of pallets within a pallet bag with an ACM on one side.

### DETAILED DESCRIPTION OF THE INVENTION

In the Summary of the Invention above, the Detailed Description of the Invention and the claims below, and the accompanying drawings, reference is made to particular features of the invention. These features can for example be components, ingredients, elements, devices, apparatus, systems, groups, ranges, method steps, test results and instructions, including program instructions.

It is to be understood that the disclosure of the invention in this specification includes all possible combinations of such particular features. For example, where a particular feature is disclosed in the context of a particular aspect or embodiment of the invention, or a particular claim, or a particular Figure, that feature can also be used in combination with and/or in the context of other particular aspects, embodiments, claims and Figures, and in the invention generally, except where the context excludes that possibility.

The invention disclosed herein, and the claims, include embodiments not specifically described herein and can for example make use of features which are not specifically described herein, but which provide functions which are the same, equivalent or similar to, features specifically disclosed herein.

The term “comprises” and grammatical equivalents thereof are used herein to mean that, in addition to the features specifically identified, other features are optionally present For example, a composition or device “comprising” (or “which comprises”) components A, B and C can contain only components A, B and C, or can contain not only components A, B and C but also one or more other components.

The term “consisting essentially of” and grammatical equivalents thereof is used herein to mean that, in addition to the features specifically identified, other features may be present which do not materially alter the claimed invention.

The term “at least” followed by a number is used herein to denote the start of a range beginning with that number (which may be a range having an upper limit or no upper limit, depending on the variable being defined). For example, “at least 1” means 1 or more than 1, and “at least 80%” means 80% or more than 80%.

The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When a range is given as “(a first number) to (a second number)” or “(a first number)−(a second number)”, this means a range whose lower limit is the first number and whose upper limit is the second number. For example, “from 8 to 20 inch” or “8-20 inch” means a range whose lower limit is 8 inch, and whose upper limit is 20 inch. The terms “plural”, “multiple”, “plurality” and “multiplicity” are used herein to denote two or more than two features.

Where reference is made herein to a method comprising two or more defined steps, the defined steps can be carried out in any order or simultaneously (except where the context excludes that possibility), and the method can optionally include one or more other steps which are carried out before any of the defined steps, between two of the defined steps, or after all the defined steps, except where the context excludes that possibility.

Where reference is made herein to “first” and “second” features, this is generally done for identification purposes; unless the context requires otherwise, the first and second features can be the same or different, and reference to a first feature does not mean that a second feature is necessarily present (though it may be present).

Where reference is made herein to “a” or “an” feature, this includes the possibility that there are two or more such features (except where the context excludes that possibility).

Thus, there may be a single such feature or a plurality of such features.

Where reference is made herein to two or more features, this includes the possibility that the two or more features are replaced by a lesser number or greater number of features which provide the same function, except where the context excludes that possibility.

The numbers given herein should be construed with the latitude appropriate to their context and expression; for example, each number is subject to variation which depends on the accuracy with which it can be measured by methods conventionally used by those skilled in the art at the date of filing of this specification.

The term “and/or” is used herein to mean the presence of one or more of the possibilities stated before and after “and/or”. The possibilities can for example be components, ingredients, elements, devices, apparatus, systems, groups, ranges and steps) is present. For example, “item A and/or item B” discloses three possibilities, namely (1) only item A is present, (2) only item B is present, and (3) both item A and item B are present. For example, “ item A and/or item B and/or item C” discloses seven possibilities, namely (1) only item A is present, (2) only item B is present, (3) only item C is present, (4) both item A and item B are present, but item C is not present, (5) both item A and item Care present, but item B is not present, (6) both item B and item C are present, but item A is not present, and (7) all of item A, item B and item C are present.

Where this specification refers to a component “selected from the group consisting of” two or more specified sub-components, the selected component can be a single one of the specified sub-components or a mixture of two or more of the specified sub-components.

If any element in a claim of this specification is considered to be, under the provisions of 35 USC 112, an element in a claim for a combination which is expressed as a means or step for performing a specified function without the recital in the claim of structure, material, or acts in support thereof, and is, therefore, construed to cover the corresponding structure, material, or acts described in the specification and equivalents thereof, then the corresponding structure, material, or acts in question include not only the corresponding structure, material, or acts explicitly described in the specification and the equivalents of such structure, material, or acts, but also such structure, material, or acts described in the US patent documents incorporated by reference herein and the equivalents of such structure, material, or acts. Similarly, if any element (although not specifically using the term “means”) in a claim of this application is correctly construed as equivalent to the term means or step for performing a specified function without the recital in the claim of structure, material, or acts in support thereof, then the corresponding structure, material, or acts in question include not only the corresponding structure, material, or acts explicitly described in the specification and the equivalents of such structure, material, or acts, but also such structure, material, or acts described in the US patent documents incorporated by reference herein and the equivalents of such structure, material, or acts.

This specification incorporates by reference all documents referred to herein and all documents filed concurrently with this specification or filed previously in connection with this application, including but not limited to such documents which are open to public inspection with this specification.

The invention is particularly useful in connection with the transport of respiring biological materials in a container, particularly a shipping container or a trucking trailer, which may be refrigerated; and the invention will be described chiefly with reference to such transport. However, the invention is useful for any procedure in which items are loaded into a bag and the items are enclosed in the bag.

In some embodiments of the invention, the different components of the bag comprise a polymeric sheet. The term “polymeric sheet” is used in this specification to denote a sheet composed of a polymeric composition which is based on a polymer or a mixture of polymers, and which optionally contains additional, e.g. conventional, additives. The polymeric composition can optionally be pigmented or otherwise tinted.

In one embodiment the pallet bag material contains one or more specialty additives, including additives having one or more of the following properties: anti-microbial; anti-fungal; photobiodegradable; oxo-photobiodegradable; UV blocker; anti-drag; anti-scratch; print enhancer; anti-static; anti-fog; pro-release; and pest repellant (e.g., ant, rodent). The material may optionally contain metallic silver particles, zeolites, organic micro-particles, titanium dioxide, and silica, as well as other additives to aid in the process and promotion of packaged biological materials.

In some embodiments an insecticide, anti-microbial, fungicide, anti-fungal, or a mold-inhibiting compound may be added to the atmosphere within the pallet bag, outside the pallet bag or both, such as the additives disclosed in U.S. Pat. No. 14/480,625, which is incorporated by reference herein in its entirety. The additive may be injected directly into the pallet bag or injected into the atmosphere outside the pallet bag to be drawn into the pallet bag through the membrane. This may be particularly useful if the biological material in the pallet is a fruit, such as apples, apricots, avocados, blackberries, blueberries, cherimoyas, dates, figs, mangos, melons, peaches, papayas, pears, pineapples, peppers, persimmons, plums, cherries, strawberries, grapes, lemons, oranges, tomatoes, raspberries, nectarines, and kiwis. The membrane may comprise a microporous film and an OTR, at all temperatures between 20 and 25° C., of at least 50,000 ml/100 inch2.atm.24 hr.

The polymer can be any suitable polymer, for example a polyolefin such as polyethylene or polypropylene, or a polyamide. The sheets may be extruded, including by a blown extrusion process which produces a tubular product, cast or otherwise prepared. The polymeric compositions in the different components of the bags can be the same or different. The polymeric sheets can for example be 1-50 mil thick, for example 1-20 mil thick, e.g. 3-10 mil thick, e.g. 4-8 mil thick, e.g., 3.5 mil thick.

The polymeric sheet can be reinforced, particularly when it is part or all of the base or part or all of a lower section of the walls. The reinforcement can be of any kind, and can for example comprise netting composed of polymeric or other materials and/or woven material composed of polymeric or other materials, and/or strands of any description, for example polymeric strands (which may be based on the same or a different polymer as the polymeric sheet), and/or glass fibers, and/or wooden fibers, and/or corrugated materials. The thickness of any reinforcing material can vary, depending on the need, and may be 1-50 mil thick, preferably 2-20 mil.

The First Aspect of the Invention.

In a first aspect, this invention provides a bag which can be used to enclose items, the bag comprising

(1) a base, and

(2) walls which (i) are attached to each other, (ii) can be folded around the base to facilitate placing the items on the base, and (iii) can be unfolded to extend upwards from the base to enclose items that have been placed on the base; the base having properties, for example tear strength and/or puncture resistance and/or stiffness, which reduce the danger that the base will be damaged by imperfections in a surface onto which the base is put. The base can be composed of any suitable material or mixture of materials, for example likely polymeric materials as described above, and/or metallic materials and/or wooden materials, for example plywood.

The base portion can comprise (i) inside portions composed of a polymeric sheet material and (ii) outside portions which provide a protective band of material around the periphery of the bag. The outside portion can comprise a polymeric sheet material having enhanced properties, for example tear strength and/or puncture resistance and/or stiffness greater than the inside portions. The protective band can be secured to the inside portions of the walls by heat sealing and/or by an adhesive.

Use of a bag comprising a base which is strong and resistant to puncture generally eliminates the current need to place a deck sheet on the upper surface of the pallet before the bag is placed on the pallet. This results in a valuable reduction in the cost of labor as well as the cost of the deck sheet. However, the invention includes the possibility that a deck sheet is placed on the upper surface of a pallet before the novel bag is placed on the pallet.

In some embodiments, the base comprises a horizontal portion and vertical portions which extend upwards from the edges of the horizontal portion.

Each of the walls of the bag comprises a lower portion and an upper portion, and optionally one or more intermediate portions, the lower portion being connected to the base and to the upper portion, and the upper portion comprising, and preferably consisting of, a polymeric sheet so that the walls can be folded around the base and unfolded to extend upwards from the base. The lower portion can consist of the same sheet material as the upper portion. Preferably however, at least the outer surface of the lower portion is composed of a material having properties, for example tear strength and/or puncture resistance and/or stiffness, which reduce the danger that the walls will be damaged by contact with adjacent surfaces, for example adjacent pallets. Thus, the lower portions can comprise (i) inside portions composed of a polymeric sheet material and (ii) outside portions which provide a protective band of material around the periphery of the bag. The outside portions can comprise a polymeric sheet material having enhanced properties, for example tear strength and/or puncture resistance and/or stiffness greater than the inside portions. The protective band can be secured to the inside portions of the walls by heat sealing and/or by an adhesive. The protective band can for example extend a distance of at least 1 inch, preferably at least 4 inch, above the horizontal base, and up to 12 inch, for example up to 6 inch, above the horizontal base.

When the base comprises a horizontal portion and vertical portions which extend upwards from the edges of the horizontal portion, the vertical portions of the base can provide all or part of the protective band around the bottom of the bag.

The bag can optionally have one or more of the following characteristics.

(a) The base comprises a polymeric material having toughness and/or puncture resistance and/or stiffness such that the base is not liable to be damaged when it is placed on top of a pallet, preferably toughness and/or puncture resistance and/or stiffness which is significantly greater, for example at least three times the corresponding property of the polymeric sheet in the upper portions of the walls. The properties of the base of the walls can be assessed using one or more ASTM tests, including but not limited to ASTM 01894, 0882, 01922, 02582, D1709, D2457 and D1003, and the like, for example Elmendorf tear strength, puncture resistance and elongation. In one embodiment, the base comprises a polymeric sheet that is reinforced, for example by strands.

(b) The lower portions of the walls provide a protective band around the base of the bag. The lower portions can comprise materials having toughness and/or puncture resistance and/or stiffness such that the lower portions are not liable to be damaged by contact with another surface, for example the side of an adjacent loaded pallet or a wall of a container. The lower protective band can extend up the sides of the bag by, for example, a distance of 1-12 inch, preferably 4-6 inch. The lower portions of the walls can comprise the same polymeric materials as the base, or different polymeric materials.

Use of a bag in which the walls of the bag have such a protective band is more economical, particularly in terms of labor, than applying a separate protective band to the lower portions of a preformed bag.

The protective band around the bottom of the bag can comprise a reinforced polymeric sheet, for example a polymeric sheet that is reinforced by strands, e.g. polymeric strands. In one embodiment, the lower portions of walls comprise the same material as the base. In one such embodiment, the base and the lower portions of the walls can comprise different parts of a single sheet of polymeric material.

The base comprises

(a) a first sheet of a material having a tear strength which is substantially greater than the tear strength of the upper portions of the walls and/or having a puncture resistance which is substantially greater than the puncture resistance of the upper portion of the walls, and second sheets of polymeric material which are horizontal extensions of the lower portions of the walls, the first and second sheets being secured to each other by heat-sealing and/or by an adhesive.

(b) The shape of the base is a rectangle (including square).

(c)At least the upper portions of the walls are derived from a tube of a polymeric composition. The tube can provide not only the upper portions but also part or all of the lower portions of the walls. The tube can provide not only the upper portions and part or all of the lower portions of walls, but also part of the horizontal base of the bag, in the form of flattened parts of the tube which are secured to other parts of the horizontal base by heat sealing and/or by use of an adhesive.

(d) At least one of the upper portions of the walls comprises at least one hole which remains accessible when the top of the bag is gathered together to seal the bag. At some stage in the preparation of a bag enclosing a respiring biological material, an atmosphere control member (ACM) is placed over the hole so that, when the bag is sealed around a respiring biological material, the atmosphere around the respiring biological material is controlled by the atmosphere control member. For details of atmosphere control members, reference may be made, for example, to U.S. Pat. No. 4,879,078 (Antoon), U.S. Pat. No. 4,910,032 (Antoon), U.S. Pat. No. 4,923,703 (Antoon), U.S. Pat. No. 4,987,745 (Harris), U.S. Pat. No. 5,041,290 (Wallace et aL) U.S. Pat. No. 5,045,331 (Antoon), U.S. Pat. No. 5,063,753 (Woodruff), U.S. Pat. No. 5,160,768 (Antoon), U.S. Pat. No. 5,254,354 (Stewart U.S. Pat. No. 6,013,293 (De Moor), U.S. Pat. No. 6,210,724 (Clarke et al.), U.S. Pat. No. 6,376,032 (Clarke et al.), U.S. Pat. No. 6,548,132 (Clarke et al.), U.S. Pat. No. 7,329,452 (Clarke), U.S. Pat. No. 7,601,374 (Clarke), U.S. Pat. No. 7,801,374 (Clarke), WO 96/38495 (Landec), WO 00/04787 (Landec), WO 01/92118 (Landec), WO 03/043447 (Landec), and WO 2005/074466 (Landec); and European Applications Nos. 0,351,115 and 0,351,116 (Courtaulds). Preferred atmosphere control members for use in this invention comprise a porous substrate and coating on the porous substrate of an organic polymer. The disclosure of each of those patents, applications and publications is incorporated herein by reference in their entirety for all purposes.

(e) At least one of the flexible walls, preferably in an upper part of the wall, which remains exposed after the bag has been sealed and a plurality of bags have been placed together in a container, comprises

(i) one or more holes, each of which is covered by an atmosphere control member, preferably an atmosphere control member comprising a porous substrate and a coating of a polymeric composition, and/or

(ii) perforations so that, when the bag is sealed around a respiringbiological material, the atmosphere around the respiring biological material is in part or completely controlled by the perforations.

(f) When adhesive is used to secure components of the bag to each other, the adhesive should be one which is appropriate to the items enclosed In the bag. Thus, when the items are respiring biological materials, the adhesive is preferably water-based and does not impart any odors or residuals to the bag.

(g) The pallet bags may be made in a wide range of dimensions to fit a wide range of pallet sizes and appropriate to the dimensions of the product load to be placed in the bag. For example, a common pallet size in the USA is 48 inches by 40 inches and the load often conforms to these dimensions as well. Therefore, the pallet bag may have dimension of 48-52 inches along one side and 40-42 inches along the other side. The height of the bag may vary depending on the height of the load but is generally in the range of 20-140 inches, for example 60-100 inches.

(h) The pallet bags may be constructed by a number of means known in the art including but not limited to blowing a tube of a polymeric composition to an appropriate diameter, flattening the tube (with or without gussets), cutting or perforating the tube to a desired length, followed by either

(i) sealing the bottom of the tube to form a bag, or

(ii) securing the bottom of the bag to the horizontal base of bag, for example by heat sealing and/or through the use of an adhesive

When the bag is used to package a respiring biological material, one or more holes are preferably made in the upper portions of the walls and before or after the bag is sealed, an atmosphere control member is placed over each hole. The quantity of respiring biological material can vary widely, for example 50-5000 lbs, e.g. 50-3000 lbs, preferably 100-2500 lbs, for example 500-1500 lbs, or less. The size, location and number of holes will depend upon the load.

Fath of the holes can, for example, be or have an area corresponding to, a hole 0.1-20 inch, generally 1-20 inches, e.g. 1-10 inches, or 2-7 inches, in diameter. In one embodiment, an ACM in the form of a strip is incorporated into the walls of the bag. The atmosphere control member, which is preferably one of the atmosphere control members sold by Landec or Apia under the tradename “BreatheWay”, can for example be 10 inch×10 inch, or 8.25 inch×8.25 inch, or 6.5 inch×6.5 inch.

When the pallet including the bag is one of a number of pallets loaded into a container, it is preferable for the ACM(s) to be positioned near enough to the top of the bag in order to minimize the danger that the ACM will be blocked by shifting of an adjacent pallet. In other circumstances, e.g. simple storage of the bag, the ACM(s) can be placed wherever it is convenient.

The Second Aspect of the Invention.

In a second aspect, this invention provides an assembly which comprises

(1) a horizontal surface, for example the top surface of a pallet, and

(2) a bag according to the first aspect of the invention, the base of the bag being in contact with the horizontal surface.

In this assembly, the walls of the bag are folded downwards while the items to be enclosed are placed on the base, and the walls are subsequently unfolded so that the items are enclosed by the bag, and optionally the tops of the upper portions of the bag are secured together to seal the bag. The bag can be hermetically sealed or sealed in such a way that there is a small passageway which helps to equilibrate the pressure inside and outside the bag.

The Third Aspect of the Invention.

In a third aspect, this invention provides a method of making an assembly according to the second aspect of the invention, the method comprising the steps of

(A) providing a bag according to the first aspect of the invention

(B) providing a horizontal surface, for example the top of a pallet,

(C) placing the base of the bag on the horizontal surface, with the walls folded down around the sides of the base, loading items on top of the base of the bag, and unfolding the walls of the bag so that they enclose the items.

The method is particularly useful for items that are respiring biological materials, in which case the method preferably includes a step in which one or more holes are made in the walls of the bag, and a subsequent step in which each of the one or more holes is covered by an atmosphere control member.

When a respiring biological material has been loaded into the bag, it is sometimes desirable to introduce a gas other than air into the bag after, or shortly before, the bag is sealed. For example, when the respiring biological material is berries, it is sometimes desirable to increase the carbon dioxide content of the atmosphere around the respiring biological material.

The Fourth Aspect of the Invention.

In a fourth aspect, this invention provides a method of making a pallet bag according to the first aspect of the invention, the method comprising the steps of

(A) providing a tube of a polymeric composition,

(B) flattening the tube (with or without gussets),

(C) cutting or perforating the tube to a desired length,

(D) before or after step (C), sealing the bottom of the tube to form a bag,

(E) securing the bottom of the bag to the horizontal base of the bag, for example by heat sealing and/or through the use of an adhesive.

The method is particularly useful for making pallet bags that are to be used to enclose items that are respiring biological materials, in which case the method preferably includes a step in which one or more holes are made in the tube before step (C) or in the walls of the bag, and a subsequent step in which each of the one or more holes is covered by an atmosphere control member.

The Fifth Aspect of the Invention.

In a fifth aspect, this invention provides a method of making a pallet bag according to the first aspect of the invention, the method comprising the steps of

(A) providing a base for the bag which (i) is resistant to damage and (ii) comprises a horizontal portion and vertical portions which extend upwards from the edges of the horizontal portion,

(B) securing the walls of the polymeric sheet material to the vertical portions of the base, for example by heat sealing and/or through the use of an adhesive.

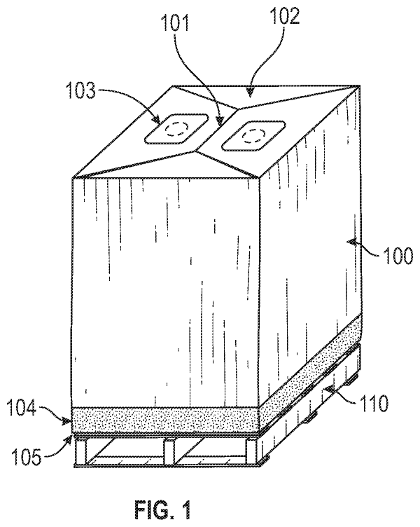

The method is particularly useful for making pallet bags that are to be used to enclose items that are respiring biological materials, in which case the method preferably includes a step in which one or more holes are made in the walls of the bag, and a subsequent step in which each of the one or more holes is covered by an atmosphere control member. In FIG. 1, the top of the bag is shown closed in a “gusset” format with the top ends tucked in, however, this could also be a design where the top ends are left hanging out.

FIG. 1 depicts an embodiment of a reinforced pallet bag 100 that surrounds materials, such as trays or boxes of biological materials, such as raspberries, strawberries or the like (not shown). The top of the bag shows the sealed gusseted closure 102 and the top middle portion 101 is closed and preferably sealed using heat, a mechanical seal, an adhesive or a combination thereof. The figure shows a plurality of ACMs 103 covering a hole in the top portion of the pallet bag. The pallet bag further shows a reinforced side portion 104 which extends below the pallet bag 105 with the entire reinforced pallet bag and contents on a pallet 110 that may be about (45″-50″)×(35″-45″) or the dimensions of the pallet bags as disclosed herein based on the contents.

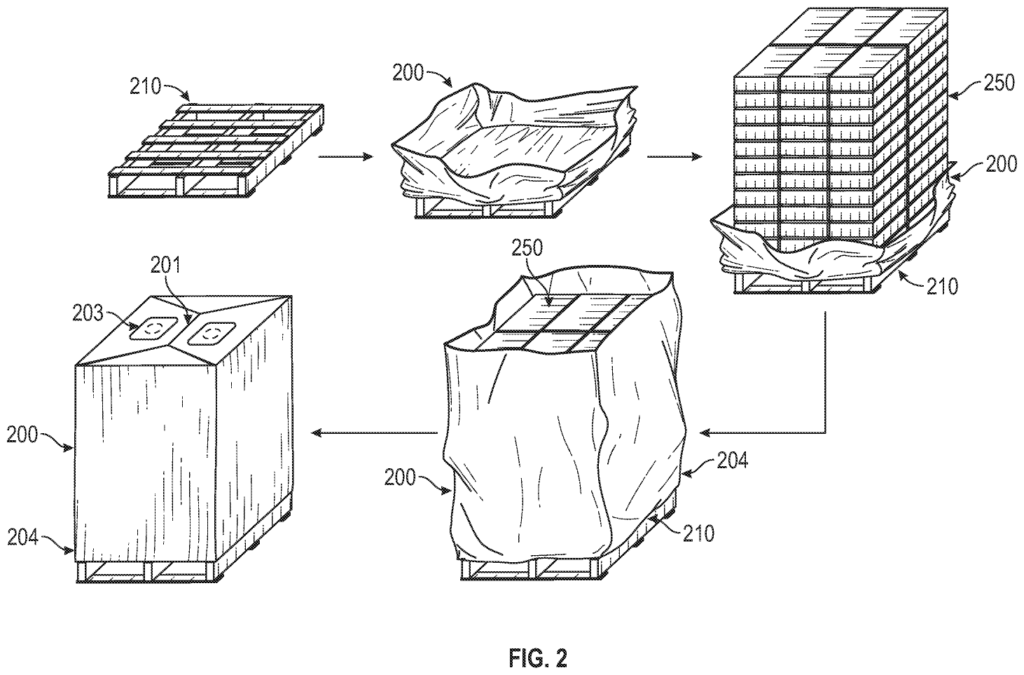

FIG. 2 displays a sequence where the pallet 210 is overlayed with a reinforced pallet bag 200. Next the product or load 250 is placed on the pallet 210 on top of the pallet bag 200. The pallet bag 200 is then raised from the bottom up to reveal the reinforced portion at the side bottom 205 and extends below the pallet bag 200 in contact with the pallet 210. The final sequence shows the pallet bag 200 much as it appears in FIG. 1 with a plurality of ACMs 203, in this case located on the top of the pallet bag but one or more ACMs may be located on the sides or where it is determined to best remain unimpeded to the flow of gasses (e.g., air). In that sequence the pallet bag gussets are folded in and a seal 201 appears.

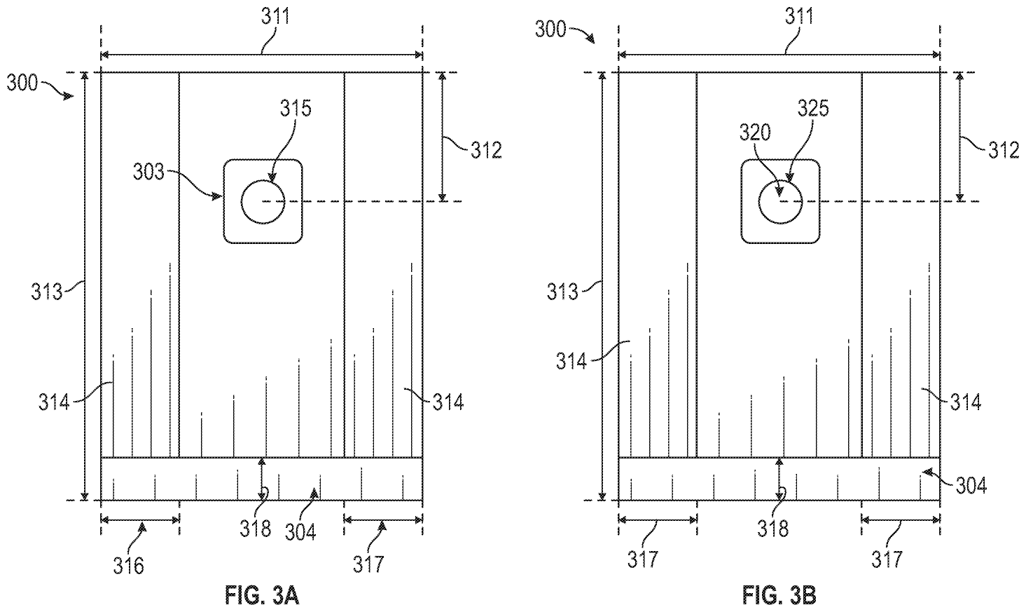

FIGS. 3A and 3B are two dimensional depictions of the pallet bags 300 from different orientations, with 3A being the front of the pallet bag and 3B being the back of the pallet bag in this example.

Example dimensions for strawberry trays or boxes may be a width 311 of from about 50″ to about 53″, preferably about 51.5″; a depth 314 of from about 40″ to about 44″, preferably about 42″; and a length 313 of from about 92″ to about 96″, preferably about 94″. The total circumference may be from about 180″ to about 194″, preferably about 186″ to about 188″. A hole is punched on both sides of the bag in one example, though one hole could be punched on one side, wherein the hole size 315 is from about 2″ to about 4″, preferably about 3″ and located about 16″ to about 20″ 312 from the open end. The film thickness may be from about 3 to about 6 mils, preferably from about 4 to about 4.4 mils. The film oxygen transmission rate (OTR) may be from about 75 to about 110 cc/100 in²/day, preferably from about 85 to about 100 cc/100 in²/day. In one example the film type is LDPE “TOUGHER”. The lower portion of the bag shows the reinforced portion 304 that may extend from about 4″ to about 8″ up the side of the pallet bag 300 from the bottom. The reinforced portion may be woven PP with dimensions of about 42″ width×about 51″ length×about 6″ height, as required by the pallet bag dimensions. The ACM 303, such as a Breatheway membrane, is placed over the hole 320. Though typically the widths are the same 317, it is possible the contours of the load may require a tapered aspect where one gusset 316 is a different size than the other gusset 317.

With different product, such as raspberry trays or boxes, the hole 320 on the front side may be the same dimensions as shown above 315 but the back side or other hole may be a different size, for example the back side hole size 325 may from from about 5″ to about 9″, preferably 7″.

The Pallet bag may be a standard thickness, for example about 2 to about 8 mil, more preferably about 3 to about 4 mil and may be composed of any plastic material, low density polyethylene (LDPE) is a preferred plastic (since by using a mechanical locking device no heat sealing is needed—but heat sealing may be applied) but any plastic monolayer, plastic laminates or multicomponent laminates or blends may be used for example, PE, PP, PET, thermoplastic elastomer, stretch plastic, Nylon, paper/plastic laminates, and the like. Other bag materials and thicknesses may be used. However, it is desirable that the upper portions of the wall material should be sufficiently flexible to be used with the mechanical seal preferably used in the pallet packaging system herein.

Suitable flexible material for the bag may be PE, PP, Nylon, polyester, recycled or repurposed plastic, low cost paper/plastic laminates, and other laminates. Preferred materials include LDPE, Linear low density polyethylene (LLDPE), ultra low density polyethylene (ULDPE).

The pallet bags, in one aspect, form part of the present invention and can be used to drive efficiency, lower costs, and to render a clean looking finished pallet with the right atmosphere. In one embodiment, a fully automated system is used from using film in the shape of a long tube that can be automatically cut to size for a custom pallet height, with the top heat sealed and holes cut over which may be placed ACM membranes, such as BreatheWay® membranes, or microperforations for atmosphere control.

The pallet bag may optionally be a custom designed bag which, when opened and placed over the pallet will have a flat top to lie smoothly over the top layer of product trays. This bag design will not leave any hanging ears, which otherwise require taping and add extra labor, cost and time. A preferred pallet bag may be designed to fit a unit load of 48″×40″ (Standard Grocery Manufacturers Association (GMA) pallet) with varying heights and will come in a roll form. Alternatively, the pallet bag may be designed for use with a sea pallet, which commonly has a size of 1200 mm×1000 mm. Alternatively, the pallet bag may be sized for a European pallet of 800 mm×1200 mm used in some parts of Europe.

Persons having ordinary skill in the art will recognize certain modifications, permutations, additions and sub-combinations of the embodiments described herein. It is intended herein to include all such modifications, permutations, additions and sub-combinations.

1. A base for attaching a pallet bag comprising:
(A) a reinforced base portion with a gusseted side portion, and a bottom portion;
(B) a reinforced portion along about 4″ to about 12″ of the side portion and at least some of the bottom portion; and
(C) optionally, a flexible and bendable semi-rigid member in at least one corner of the side portion.

2. The base according to claim 1, wherein base is attached to a pallet bag having at least one ACM.

3. The base according to claim 1, wherein the top portion has a plurality of holes covered by a plurality of ACMs.

4. The base according to claim 1, wherein at least one ACM is located on the side portion.

5. The base according to claim 1, wherein the reinforced portion is at least part polypropylene (PP) and extends at least about 4″ from the bottom portion up the side portion.

6. The base according to claim 2, wherein the pallet bag has a plurality of ACMs, at least one on the top portion.

7. The base according to claim 6, wherein the pallet bag material is from about 3 to about 6 mils in thickness.

8. The base according to claim 1, wherein the film oxygen transmission rate (OTR) is from about 85 to about 100 cc/100 in²/day.

9. The base according to claim 1, wherein the total circumference of the bag is from about 185″ to about 190″.

10. The base according to claim 1, wherein a load of biological materials is placed on the base, and the pallet bag is extended from the top of the material down over the materials, wherein the pallet bag has gusseted side portions and is attached to the about 4″ to about 12″ of the side portion over the load of materials.

11. The base according to claim 1, wherein the reinforced portion is added after attaching the pallet bag to said base.
